(19) United States
(12) Patent Application Publication
(10) Pub. No.: US 2015/0178773 A1
(43) Pub. Date: Jun. 25, 2015

(54) INFORMATION PROCESSING APPARATUS AND METHOD, AND NON-TRANSITORY COMPUTER READABLE MEDIUM

(71) Applicant: FUJI XEROX CO., LTD., Tokyo (JP)

(72) Inventors: Daisuke IKEDA, Kanagawa (JP); Masatsugu TONOIKE, Kanagawa (JP)

(73) Assignee: FUJI XEROX CO., LTD., Tokyo (JP)

(21) Appl. No.: 14/281,147

(22) Filed: May 19, 2014

(30) Foreign Application Priority Data
Dec. 25, 2013 (JP) 2013-266642

(51) Int. Cl. G06Q 30/02; G06K 9/00

(52) U.S. Cl. CPC G06Q 30/0255; G06K 9/00523

(57) ABSTRACT

An information processing apparatus includes a detector, an extracting unit, and an associating unit. The detector detects, from first information posted by a user, display device identification information for uniquely identifying a display device which displays an advertising image. The extracting unit extracts information concerning interests of the user from the first information posted by the user or second information concerning the user. The associating unit associates the display device identification information detected by the detector with the information concerning the interests of the user extracted by the extracting unit.

### CROSS-REFERENCE TO RELATED APPLICATIONS

This application is based on and claims priority under 35 USC 119 from Japanese Patent Application No. 2013-266642 filed Dec. 25, 2013.

### BACKGROUND

### Technical Field

The present invention relates to an information processing apparatus and method and a non-transitory computer readable medium.

### SUMMARY

According to an aspect of the invention, there is provided an information processing apparatus including a detector, an extracting unit, and an associating unit. The detector detects, from first information posted by a user, display device identification information for uniquely identifying a display device which displays an advertising image. The extracting unit extracts information concerning interests of the user from the first information posted by the user or second information concerning the user. The associating unit associates the display device identification information detected by the detector with the information concerning the interests of the user extracted by the extracting unit.

### BRIEF DESCRIPTION OF THE DRAWINGS

Exemplary embodiments of the present invention will be described in detail based on the following figures, wherein:

FIG. 1 is a block diagram of conceptual modules of an example of the configuration of a first exemplary embodiment;

FIG. 2 illustrates an example of the system configuration which implements an exemplary embodiment of the present invention;

FIG. 3 is a flowchart illustrating an example of processing performed by the first exemplary embodiment;

FIGS. 4A through 4D illustrate examples of items of information embedded in an advertising image;

FIG. 5 illustrates an example of the data structure of posting information;

FIG. 6 illustrates an example of the data structure of a profile table;

FIG. 7 illustrates an example of the data structure of a content table;

FIG. 8 is a block diagram of conceptual modules of an example of the configuration of a second exemplary embodiment;

FIG. 9 is a flowchart illustrating an example of processing performed by the second exemplary embodiment;

FIG. 10 illustrates an example of the data structure of a display-device/position table;

FIG. 11 illustrates an example of the data structure of an image/display-device table; and

FIG. 12 is a block diagram illustrating an example of the hardware configuration of a computer that implements an exemplary embodiment of the present invention.

### DETAILED DESCRIPTION

Exemplary embodiments of the present invention will be described below with reference to the accompanying drawings.

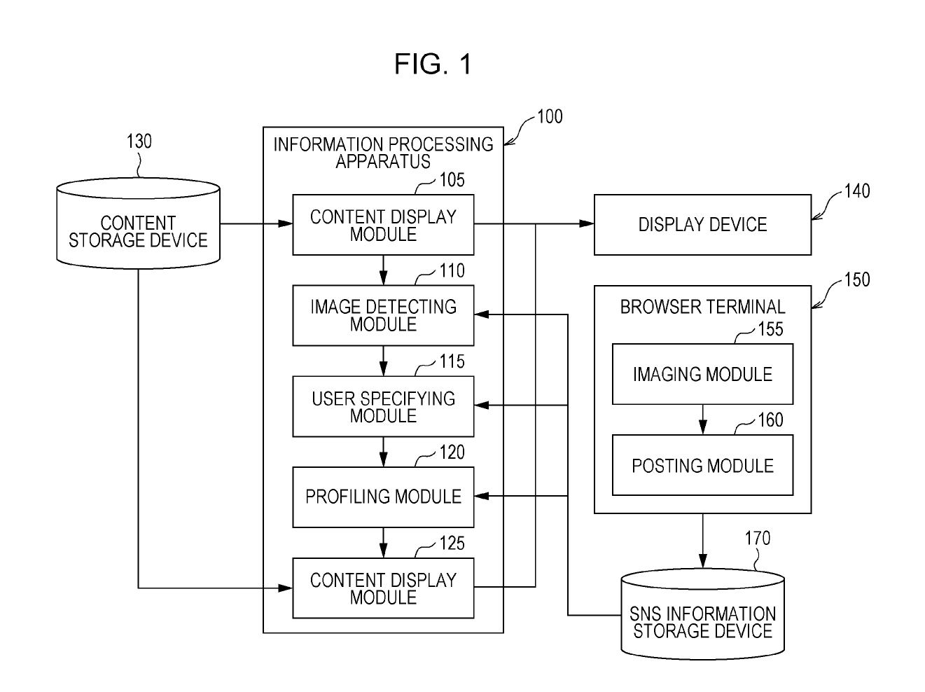

FIG. 1 is a block diagram of conceptual modules of an example of the configuration of a first exemplary embodiment.

Generally, modules are software (computer programs) components or hardware components that can be logically separated from one another. Accordingly, the modules of exemplary embodiments of the invention are not only modules of a computer program, but also modules of a hardware configuration. Thus, the exemplary embodiments will also be described in the form of a computer program for allowing a computer to function as those modules (a program for causing a computer to execute program steps, a program for allowing a computer to function as corresponding units, a computer program for allowing a computer to implement corresponding functions), a system, and a method. While expressions such as “store”, “storing”, “being stored”, and equivalents thereof are used for the sake of description, such expressions indicate, when the exemplary embodiments relate to a computer program, storing the computer program in a storage device or performing control so that the computer program is stored in a storage device. Modules may correspond to functions based on a one-on-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationship among data elements, etc.). The term “predetermined” means being determined prior to a certain operation, and includes the meaning of being determined prior to a certain operation before starting processing of the exemplary embodiments, and also includes the meaning of being determined prior to a certain operation even after starting processing of the exemplary embodiments, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is necessary.

A system or an apparatus may be realized by connecting plural computers, hardware units, devices, etc., to one another via a communication medium, such as a network (including communication based on a one-on-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

An information processing apparatus 100 of a first exemplary embodiment associates display device identification information with information concerning users' interests or associates advertisement identification information with information concerning users' interests. The information processing apparatus 100 includes, as shown in FIG. 1, a content display module 105, an image detecting module 110, a user specifying module 115, a profiling module 120, and a content display module 125. The information processing apparatus 100 is connected to a content storage device 130, a display device 140, and an SNS information storage device 170 via a communication line. The information processing apparatus 100 may contain the content storage device 130, the display device 140, or the SNS information storage device 170, or a combination thereof. A browser terminal 150 includes an imaging module 155 and a posting module 160, and is connected to the SNS information storage device 170.

The image detecting module 110 is connected to the content display module 105, the user specifying module 115, and the SNS information storage device 170. The image detecting module 110 detects, from first information posted by a user, display device identification information for uniquely identifying the display device 140 which displays an advertising image. The user is a user who owns the browser terminal 150 and who has taken a photo of the display device 140 (more precisely, an advertising image displayed in the display device 140) by using the imaging module 155 of the browser terminal 150, and has posted an article including the image of the photo of the display device 140 to a social network system (hereinafter may also referred to as a “social networking service (SNS)”). The user may be a general user, a user who owns the browser terminal 150, a browser (who views the display device 140), or a poster who posts an article to SNS according to the context.

Information posted to a social network system may correspond to first information posted by a user. Specific examples of the social network system are FACEBOOK (registered trademark) and TWITTER (registered trademark). However, the social network system is not restricted to those systems, and may be any system, such as a blog and a bulletin board system (BBS), as long as a user can be specified. In this case, “specifying a user” means that it is not necessary to specify the real name of a user, but any identification information concerning a user that can prove that information has been posted by this user is sufficient. For example, any information posted by an SNS member (user who can log in this SNS by using a user ID and a password) is “information posted by a user” in this exemplary embodiment. The first information includes an image of a picture taken by the imaging module 155 of the browser terminal 150. Then, this image includes an advertising image displayed in the display device 140.

The display device 140 which displays an advertising image is so-called digital signage. Details of digital signage will be discussed later.

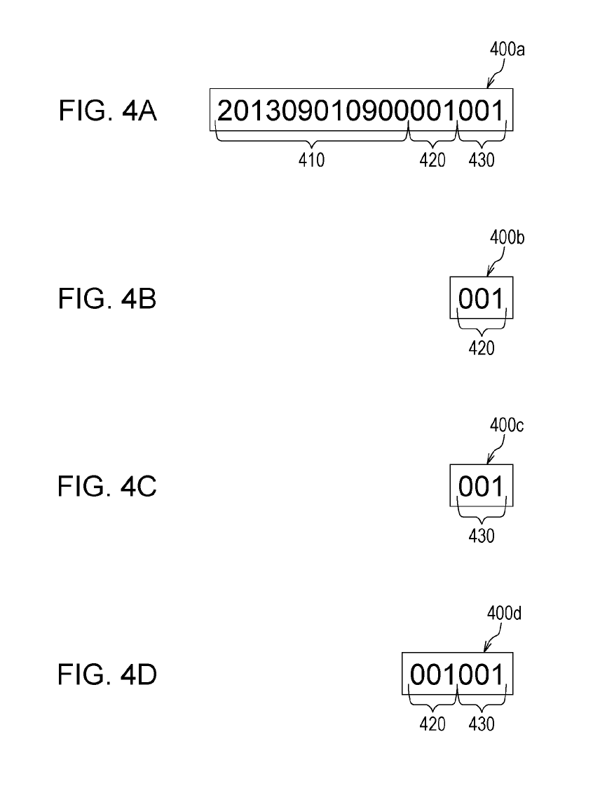

The first information may be an image obtained by taking a picture of an advertising image, and display device identification information may be embedded in this advertising image. The image detecting module 110 detects display device identification information from the image obtained by taking a picture of the advertising image. In this case, “information is embedded in an image” means that information may be contained in the image in any manner as long as the information can be extracted from this image. This will be discussed later in more details with reference to the examples shown in FIGS. 4A through 4D.

The image detecting module 110 may detect advertisement identification information for uniquely identifying an advertising image displayed in the display device 140 from the first information posted by a user.

In this case, the first information may be an image obtained by taking a picture of an advertising image, and advertisement identification information may be embedded in this advertising image. The image detecting module 110 detects advertisement identification information from the image obtained by taking a picture of the advertising image.

The first information may be an image obtained by taking a picture of an advertising image, and advertisement identification information may not be embedded in this advertising image. In this case, the image detecting module 110 compares part of the advertising image with a predetermined advertising image, and detects advertisement identification information concerning this advertising image. There may be plural predetermined advertising images, and may be restricted to images displayed in a display device lately, and more specifically, images displayed during a preset period from the past to the present. Detecting of advertisement identification information is performed by utilizing a matching technique for comparing advertising images with each other. Matching between an advertising image A stored in the content storage device 130 and part of an image B of a picture taken by the imaging module 155 of the browser terminal 150 is performed, and advertisement identification information of the advertising image A which matches the image B is used as a detection result. In this case, image features of the advertising image A and part of the image B are extracted, and it is determined, on the basis of the distance between image features in a feature space, which advertising image A matches part of the image B. Alternatively, the difference between the advertising image A and part of the image B may be found. A frame of the display device 140 may be extracted as part of the image B, and an image within this frame may be compared with the advertising image A. For example, for extracting a frame, the aspect ratio of a display area of the display device 140 may be measured in advance, and a rectangular portion having this aspect ratio may be extracted from the image B. Before performing matching processing, affine transformation may be performed on the image B or an image within a frame of the image B in order to correct distortions occurred when a picture is taken.

The user specifying module 115 is connected to the image detecting module 110, the profiling module 120, and the SNS information storage device 170. The user specifying module 115 specifies a user who has posted the image from which display device identification information concerning the display device 140 has been detected by the image detecting module 110. In this case, the user has taken a picture of the display device 140 by using the function of the imaging module 155 of the browser terminal 150. Accordingly, it is highly likely that this user will view the display device 140 from now, and thus, an advertising image which matches the user's interests is displayed in the display device 140. The user specifying module 115 specifies such a user who has posted information including this image to SNS as an SNS member. Thus, the user specifying module 115 is also able to obtain information posted by this user in the past and profile information concerning the user which is made open.

The profiling module 120 is connected to the user specifying module 115, the content display module 125, and the SNS information storage device 170. The profiling module 120 extracts information concerning the interests of a user who has posted the first information from the first information and second information concerning this user. Then, the profiling module 120 associates the display device identification information detected by the image detecting module 110 with the extracted information (hereinafter may be called a “genre”) concerning the user's interests.

The first information is information posted to SNS including an advertising image. The second information is information concerning a user managed by this SNS, and more specifically, posted information or profile information concerning a user which is made open. If the second information is posted information, the first information is generally the later information, and the second information has been posted prior to the first information. Specific examples of the profile information concerning a user are the gender, age, hobbies, address, and academic or professional affiliation (school or company) of this user. Additionally, other items of information, such as the past purchase history and browsing history, may be included. Information concerning the user's interests is extracted by using a known so-called profiling technique. For example, a dictionary in which words and interests are associated with each other may be prepared. Then, words used in posted information may be extracted by using morphological analysis, and interests associated with the extracted words may be extracted by using this dictionary.

The content display module 105 is connected to the image detecting module 110, the content storage device 130, and the display device 140. The content display module 105 sends an advertising image (content) stored in the content storage device 130 to the display device 140 so as to display this advertising image in the display device 140. In this case, the content display module 105 embeds, in the advertising image, identification information concerning the display device 140 which displays this advertising image. The content display module 105 also embeds identification information concerning this advertising image in the advertising image. The content display module 105 may also embed time-and-date information (may be millisecond, second, minute, hour, day, month, and year, or a combination thereof) in the advertisement information. The content display module 105 may embed a combination of the above-described items of information in the advertising image. Embedding of information will be discussed later with reference to the examples shown in FIGS. 4A through 4D.

The content display module 125 is connected to the profiling module 120, the content storage device 130, and the display device 140. The content display module 125 selects an advertising image on the basis of information concerning the user's (poster's) interests and sends the advertising image to the display device 140 so that the advertising image will be displayed in the display device 140. In this case, the content display module 125 selects an advertising image which is highly likely to interest a user is selected. More specifically, a table in which items of information concerning interests and advertising images are associated with each other is prepared, and an advertising image associated with an item of information concerning a user's interest is extracted.

The content display module 125 may embed, in the advertising image, identification information concerning the display device 140 which displays an advertising image. The content display module 125 may also embed identification information concerning an advertising image in the advertising image. The content display module 125 may also embed time-and-date information in an advertising image. The content display module 125 may embed a combination of the above-described items of information in an advertising image. Embedding of information will be discussed later with reference to the examples shown in FIGS. 4A through 4D. The content display module 125 may display an advertising image in a display device of the browser terminal 150 as well as in the display device 140, which serves as digital signage. For example, the content display module 125 may display an advertising image on an SNS screen in which a user of the browser terminal 150 is logging.

The content storage device 130 is connected to the content display modules 105 and 125 of the information processing apparatus 100. The content storage device 130 stores therein advertising images (content items). Upon receiving access from the content display module 105 or 125, one or plural advertising images stored in the content storage device 130 are sent to and displayed in the display device 140. Examples of the data format of the advertising images are JPEG for images and Hyper Text Markup Language (HTML) for text.

The display device 140 is connected to the content display modules 105 and 125 of the information processing apparatus 100. The display device 140 receives an advertising image from the content display module 105 or 125 and displays the received advertising image in the display device 140, thereby presenting the advertising image to a user. In this case, the user may be a user of the browser terminal 150. However, it is not always necessary that the user of the browser terminal 150 see the advertising image, and instead, it is sufficient if there is a possibility that the user of the browser terminal 150 may see this advertising image. The display device 140 is so-called digital signage. Digital signage is an advertising medium which displays video or information by using a display device, such as a display or a projector, by utilizing digital technologies for display and communication. The display device 140 may be installed in any location where there is a possibility that users may view the display device 140. The display device 140 may be installed, for example, near a cash register in a store or on the platform in a station, and, more preferably, in an environment where users may view the display device 140 for a considerably long time, such as in a train or in a hairdresser salon. More specifically, if the display device 140 is installed in an environment where a user views the display device 140, and then posts information to SNS, and still continues to view the display device 140 after posting, advertising images that match the user's interests may be effectively displayed by using the information processing apparatus 100 of this exemplary embodiment. However, the display device 140 does not necessarily have to be installed in such an environment. For example, if there is a possibility that the same user may repeatedly (for example, the same time during weekdays) view the display device 140, advertising images that match the user's interests may be effectively displayed at a time when the user views the display device 140 next time by using the information processing apparatus 100 of this exemplary embodiment.

The browser terminal 150 is connected to the SNS information storage device 170. The browser terminal 150 is a terminal used by a user, and is, for example, a cellular phone (including a smartphone) or a personal digital assistant, such as a digital tablet.

The imaging module 155 is connected to the posting module 160. The imaging module 155 is a digital camera contained in the browser terminal 150, and takes a picture of the display device 140 in response to an operation performed by a user so as to generate an image of the display device 140 (this image including an advertising image displayed in the display device 140).

The posting module 160 is connected to the imaging module 155. The posting module 160 posts an image of a picture taken by the imaging module 155 to SNS in response to an operation performed by a user.

The SNS information storage device 170 is connected to the image detecting module 110, the user specifying module 115, and the profiling module 120 of the information processing apparatus 100 and to the browser terminal 150. The SNS information storage device 170 stores therein information posted to SNS (including images of pictures taken by the imaging module 155) and information concerning SNS members (second information).

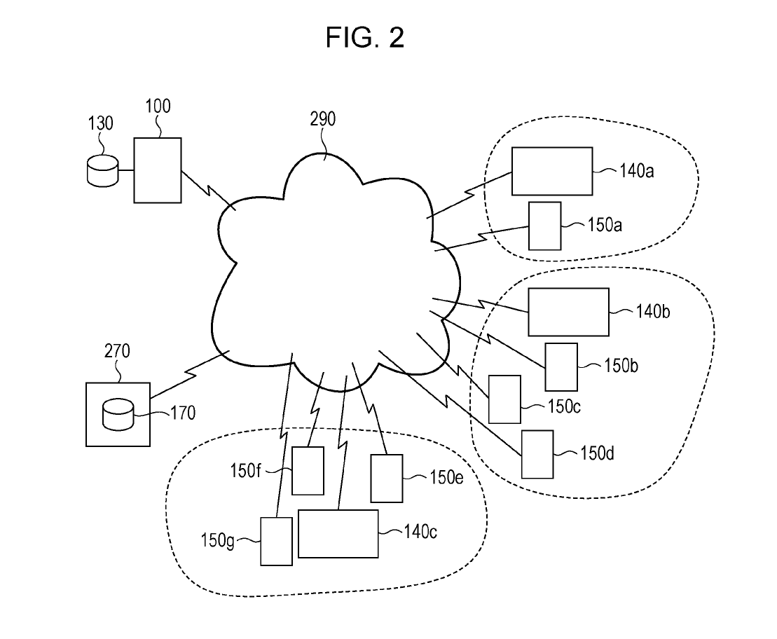

FIG. 2 illustrates an example of the system configuration which implements an exemplary embodiment of the present invention.

The information processing apparatus 100, an SNS processor apparatus 270, display devices 140a through 140c, and browser terminals 150a through 150g are connected to each other via a communication line 290. The SNS processor apparatus 270 includes the SNS information storage device 170, and provides SNS services to the browser terminals 150a through 150g. The information processing apparatus 100 sends advertising images stored in the content storage device 130 to the display devices 140a through 140c. The communication line 290 is a wireless or wired medium, or a combination thereof.

There is a browser (user) who owns the browser terminal 150a near the display device 140a. There are browsers who own the browser terminals 150b, 150c, and 150d near the display device 140b. There are browsers who own the browser terminals 150e, 150f, and 150g near the display device 140c. Among these browsers, there is a browser who takes a picture of the display device 140 and posts an image obtained by taking the picture to SNS provided by the SNS processor apparatus 270. Then, the information processing apparatus 100 collects, from the SNS provided by the SNS processing apparatus 270, information concerning the interests of the browser who has posted the image of the display device 140, and displays an advertising image that matches the browser's interests in the display device 140 that the browser is viewing.

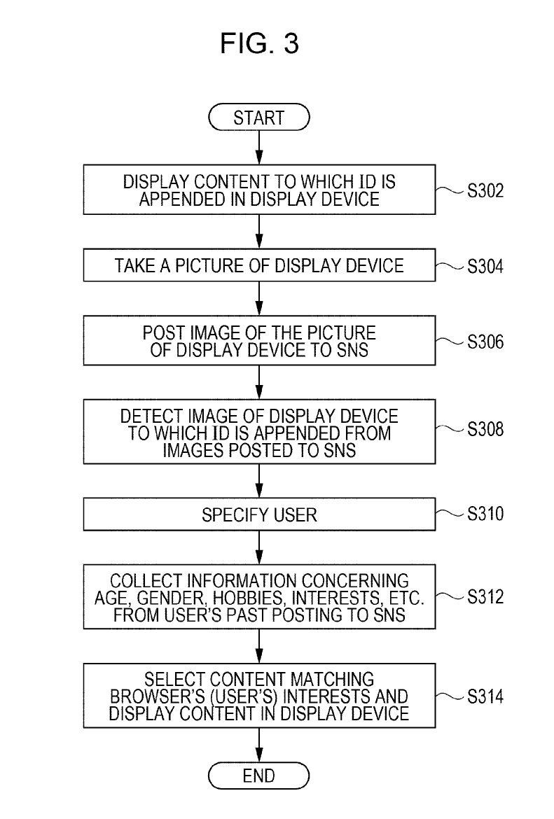

FIG. 3 is a flowchart illustrating an example of the processing performed by the information processing apparatus 100 of the first exemplary embodiment.

In step S302, the content display module 105 displays an advertising image (content) to which identification (ID) is appended in the display device 140. The ID appended to an advertising image will be discussed below with reference to the examples shown in FIGS. 4A through 4D.

FIGS. 4A through 4D illustrate examples of items of information (IDs) embedded in an advertising image. Embedded information 400a shown in FIG. 4A is constituted by a time-and-date region 410, a content ID region 420, and a display device ID region 430. The embedded information 400a is displayed in the display device 140 such that the time and date at which the advertising image is displayed in the display device 140 (time-and-date region 410), identification information concerning the advertising image (content ID region 420), and identification information concerning the display device 140 (display device ID region 430) can be identified. It is now assumed that the time and date at which the advertising image is displayed is 9:00, Sep. 1, 2013, the identification information concerning the advertising image is 001, and the terminal number of the display device 140 is 001. In this case, the embedded information 400a is represented by “201309010900001001”.

As a technique for embedding identification information in an advertising image, identification information itself (such as alphanumeric characters) may be displayed. Alternatively, identification information may be converted into a barcode (including a two-dimensional barcode), and this barcode may be displayed. Instead of directly embedding identification information in an advertising image, identification information may be specified in the following manner. For example, combinations of feature quantities extracted from advertising images and items of identification information may be registered in the information processing apparatus 100. More specifically, combinations of feature quantities extracted from advertising images in advance and items of identification information are registered in the information processing apparatus 100 in advance. Then, a feature quantity extracted from an advertising image of a picture taken by the imaging module 155 of the browser terminal 150 is checked against the feature quantities stored in the information processing apparatus 100 so as to find a feature quantity that matches the feature quantity extracted from the advertising image. Then, the item of identification information associated with the found feature quantity is specified.

After specifying identification information in this manner, processing is performed in the same manner as that for the embedded information 400a shown in FIG. 4A.

As information to be embedded in an advertising image, the following items of information may be embedded instead of the embedded information 400a shown in FIG. 4A.

Embedded information 400b shown in FIG. 4B is constituted by the content ID region 420.

Embedded information 400c shown in FIG. 4C is constituted by the display device ID region 430.

Embedded information 400d shown in FIG. 4D is constituted by the content ID region 420 and the display device ID region 430.

The time-and-date region 410 may be added to each of the embedded information 400b, the embedded information 400c, and the embedded information 400d.

In step S304, in response to an operation performed by a user, the imaging module 155 takes a picture of the display device 140 which is displaying the advertising image displayed in step S302. Since the ID is embedded in the advertising image, an image of the picture taken by the imaging module 155 contains this ID.

In step S306, the posting module 160 posts an image of the picture of the display device 140 to SNS in response to an operation performed by the user.

In step S308, the image detecting module 110 detects, from among images posted to SNS, the image of the display device 140 to which the ID is appended. In this case, for example, alphanumeric characters indicating the ID of the advertising image displayed in step S302 may be detected from the advertising image by using pattern matching or a character recognition technique. If the ID is indicated by a barcode, the barcode may be detected from the advertising image by using a barcode detection technique.

In step S310, the user specifying module 115 specifies a user. That is, the user specifying module 115 specifies the user who has posted the image detected in step S308. For example, it is assumed that a browser A has posted an image in step S306 to which an ID (such as 201309010900001001) has been appended. Then, the image detecting module 110 conducts an image search on all images posted to SNS. While conducting an image search, the image detecting module 110 extracts numeric characters (201309010900001001) as the ID from the image posted in step S306 by utilizing a numeric-character recognition technique. Upon detecting the subject numeric characters, the browser A who has posted the image can be specified.

In step S312, the profiling module 120 collects information concerning the age, gender, hobbies, and interests of the user from the content of information posted to SNS in the past and the profile information.

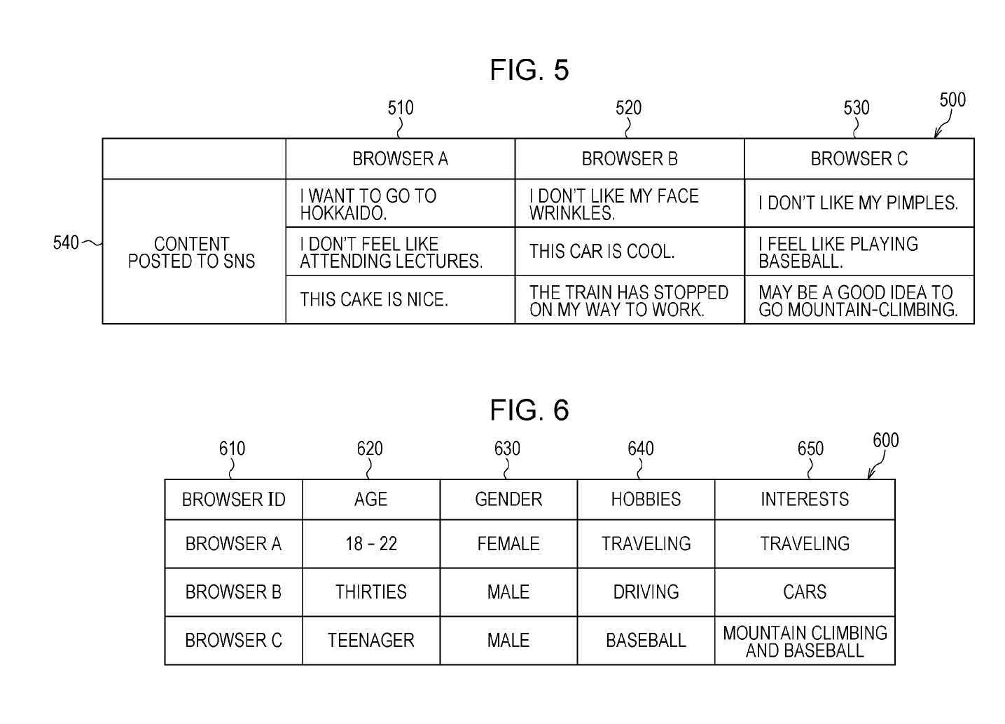

For example, the content of the posting to SNS is managed, as in posting information 500 shown in FIG. 5. FIG. 5 illustrates an example of the data structure of the posting information 500.

The posting information 500 shows that (1) “I want to go to Hokkaido.”, (2) “I don't feel like attending lectures.”, and (3) “This cake is nice.” have been posted by the browser A, that (1) “I don't like my face wrinkles”, (2) “This car is cool.”, and (3) “The train has stopped on my way to work.” have been posted by a browser B, and that (1) “I don't like my pimples.”, (2) “I feel like playing baseball”, and (3) “may be a good idea to go mountain-climbing.” have been posted by a browser C.

By utilizing a known profiling technique, the age, gender, hobbies, and interests of a browser can be estimated as follows. If a browser tweets many words concerning, for example, “lectures” and “going to school”, this browser may be a university student and this browser's age may be estimated to be around 18 to 22. If a browser tweets many words concerning, for example, cosmetics and sweets, this browser may be estimated to be a women. If a browser tweets many words concerning, for example, traveling, it may be assumed that this browser is currently interested in traveling.

Examples of the age, gender, hobbies, and interests estimated from the posting content are shown in FIG. 6. FIG. 6 illustrates an example of the data structure of a profile table 600. The profile table 600 has a browser ID field 610, an age field 620, a gender field 630, a hobby field 640, and an interest field 650.

In the browser ID field 610, information for uniquely identifying a browser (browser ID) in an exemplary embodiment is stored. In the age field 620, the gender field 630, the hobby field 640, and the interest field 650, results obtained by estimating the age, gender, hobbies, and interests, respectively, of a browser are stored. More specifically, in the age field 620, the age of a browser is stored. In the gender field 630, the gender of a browser is stored. In the hobby field 640, the hobbies of a browser are stored. In the interest field 650, the interests of a browser are stored.

The profile table 600 shows that the age “18 to 22”, the gender “female”, hobbies, “traveling”, and interests “traveling” have been estimated from the posting information 500 as the profile of the browser A, that the age “thirties”, the gender “male”, hobbies “driving”, and interests “cars” have been estimated from the posting information 500 as the profile of the browser B, and that the age “teenager”, the gender “male”, hobbies “baseball”, and interests “mountain climbing and baseball” have been estimated from the posting information 500 as the profile of the browser C.

In step S314, the content display module 125 selects the content that matches the browser's (user's) interests and displays the content in the display device 140. That is, the content display module 125 selects the content that matches the browser's interests from the profiling results and displays the selected content.

If there are plural genres of the content (advertising images) to be distributed to the display device 140, the content to be distributed may be modified so that it will be suited to the browser's interests. Examples of genres of the content are the content oriented for men, the content oriented for women, food, and traveling.

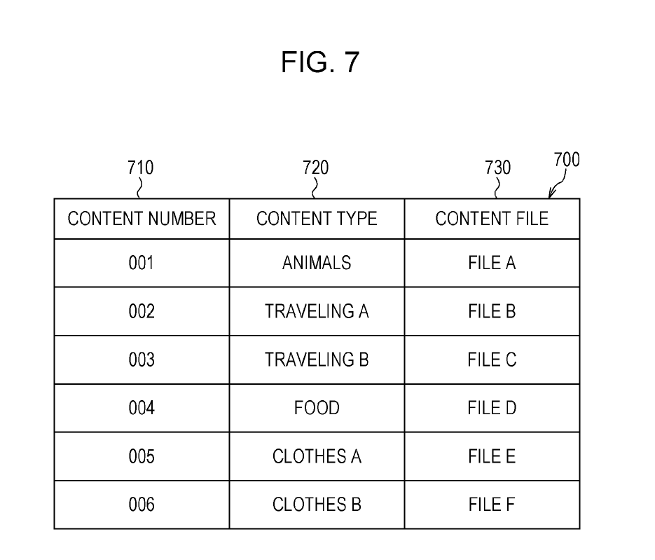

More specifically, content items to be distributed to the display device 140 are managed by using a content table 700. FIG. 7 illustrates an example of the data structure of the content table 700. The content table 700 has a content number field 710, a content type field 720, and a content file field 730. In the content number field 710, the content ID is stored. In the content type field 720, the content type indicating the genre of the content is stored. In the content file field 730, a content file (advertising image) is stored.

For example, if the browser A has posted the content 001 as a result of taking a picture of the display device 140 and if it has been estimated that the browser A is currently interested in travelling from the information posted to SNS in the past, the content 002 and the content 003 are distributed to the display device 140.

If it has been estimated that a browser is interested in the same genre as that of a displayed content item, a content item different from the displayed content item may be selected and distributed to the display device 140.

Additionally, the proportion of the area of an advertising image to an image of a picture taken by a browser may be calculated, and if the calculated proportion is equal to or greater than a predetermined threshold, the genre of the advertising image may be included as the browser's interests. The area of an advertising image may be calculated by extracting a frame of the display device 140, as discussed above.

Since the profile of a browser is discovered, behavioral targeting advertising may be performed.

Additionally, since the profiles of browsers are accumulated for each content item, they may be utilized for marketing information.

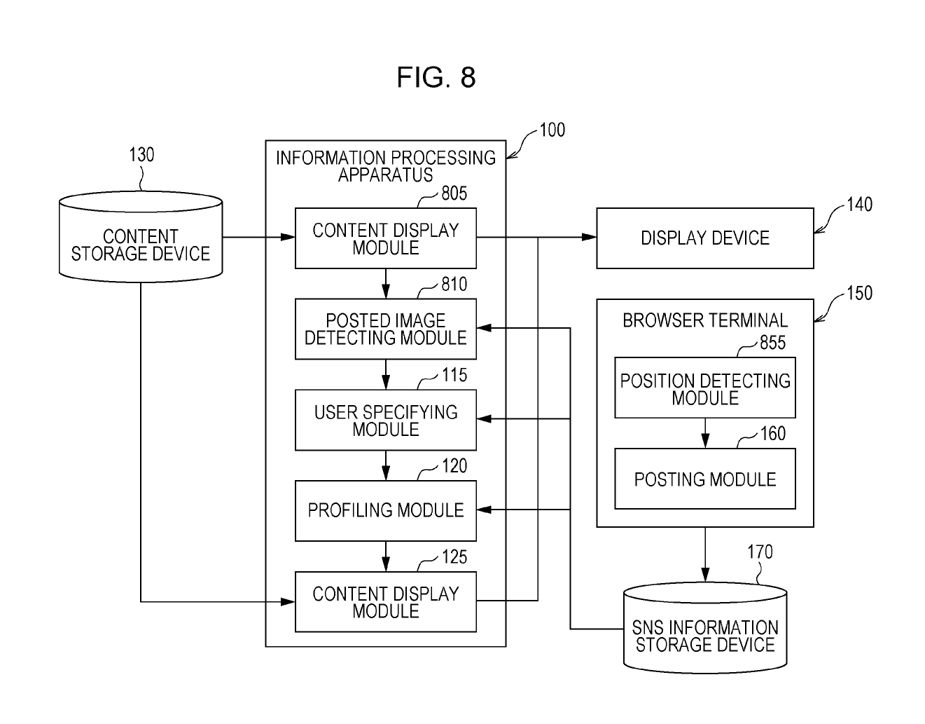

FIG. 8 is a block diagram of conceptual modules of an example of the configuration of a second exemplary embodiment. Elements equal to or similar to those of the first exemplary embodiment are designated by like reference numerals, and an explanation thereof will thus be omitted.

In the second exemplary embodiment, the browser terminal 150 posts information without taking a picture of a display device 140. However, the information posted by the browser terminal 150 includes position information (position information indicating a position of the browser terminal 150) detected by a position detecting module 855. The information processing apparatus 100 displays an advertising image which may interest the user of the browser terminal 150 in a display device 140 located near the browser terminal 150.

The information processing apparatus 100 includes, as shown in FIG. 8, a content display module 805, a posted image detecting module 810, a user specifying module 115, a profiling module 120, and a content display module 125.

The browser terminal 150 includes a position detecting module 855 and a posting module 160. The user specifying module 115 is connected to the posted image detecting module 810, the profiling module 120, and the SNS information storage device 170. The content storage device 130 is connected to the content display modules 805 and 125 of the information processing apparatus 100. The display device 140 is connected to the content display modules 805 and 125 of the information processing apparatus 100. The SNS information storage device 170 is connected to the posted image detecting module 810, the user specifying module 115, and the profile module 120 of the information processing apparatus 100 and to the browser terminal 150.

The position detecting module 855 detects a position of the browser terminal 150 by utilizing a global positioning system (GPS) or a base station used in a cellular phone network, and supplies position information concerning the detected position to the posting module 160. The posting module 160 then adds the position information received from the position detecting module 855 to information to be posted to SNS. In this case, the posting module 160 may add the position information to the content of the information to be posted, as in, for example, “information described by XXXX (a name that can specify a position)”. Examples of position information are latitude information and longitude information or a name that can specify a position. Alternatively, the position information may be added as an attribute of the information to be posted.

The content display module 805 is connected to the posted image detecting module 810, the content storage device 130, and the display device 140. The content display module 805 performs processing equivalent to that performed by the content display module 105 shown in FIG. 1. However, the content display module 805 does not have to embed display device identification information or advertisement identification information in an advertising image. That is, the content display module 805 sends an advertising image itself stored in the content storage device 130 to the display device 140 so that such an advertising image will be displayed in the display device 140.

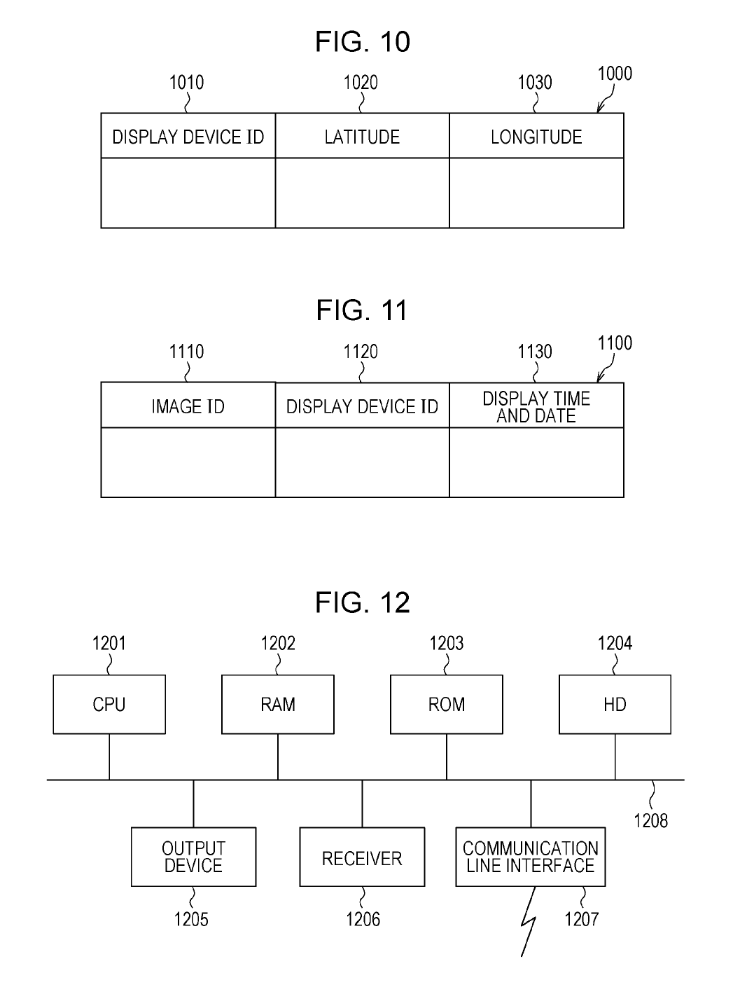

The posted image detecting module 810 is connected to the content display module 805, the user specifying module 115, and the SNS information storage device 170. The posted image detecting module 810 detects display device identification information for uniquely identifying the display device 140 which displays an advertising image from first information posted by a user. Since the first information includes position information indicating a position of a posting device used for posting the first information, the posted image detecting module 810 detects display device identification information corresponding to the position information. The positing device used for posting the first information is a browser terminal 150. Position information concerning a position detected by the position detecting module 855 contained in the browser terminal 150 is included in the first information. Then, a display device 140 installed within a predetermined range from the position of the browser terminal 150 may be extracted. For example, the position of the display device 140 is managed by using a display-device/position table 1000 shown in FIG. 10. FIG. 10 illustrates an example of the data structure of the display-device/position table 1000. The display-device/position table 1000 has a display device ID field 1010, a latitude field 1020, and a longitude field 1030. In the display device ID field 1010, information for uniquely identifying a display device 140 (display device ID) in an exemplary embodiment of the invention is stored. In the latitude field 1020, the latitude of a position at which the display device 140 is installed is stored. In the longitude field 1030, the longitude of the position at which the display device 140 is installed is stored. A display device 140 installed within a predetermined range from the position of the browser terminal 150 may be searched for by utilizing the latitude field 1020 and the longitude field 1030 of the display-device/position table 1000.

The posted image detecting module 810 may detect advertisement identification information concerning an advertising image displayed in the display device 140 corresponding to position information. For example, an advertising image displayed in the display device 140 is managed by using an image/display-device table 1100 shown in FIG. 11. FIG. 11 illustrates an example of the data structure of the image/display-device table 1100. The image/display-device table 1100 has an image ID field 1110, a display device ID field 1120, and a display time-and-date field 1130. In the image ID field 1110, information (image ID) for uniquely identifying an advertising image in an exemplary embodiment of the invention is stored. In the display device ID field 1120, the display device ID is stored. In the display time-and-date field 1130, the time and date at which the image represented by the image ID stored in the image ID field 1110 is displayed in the display device 140 represented by the display device ID is stored. The time and date indicated in the display time-and-date field 1130 may be a period (from the display start time and date to the display end time and date). As stated above, the display device 140 is specified from the position information concerning the browser terminal 150. Then, the advertising image displayed at the time and date at which the position detecting module 855 has detected the position of the browser terminal 150 (or the time and date at which positing has been performed) is specified by using the image/display-device table 1110.

The user specifying module 115, the profiling module 120, and the content display module 125 perform processing equivalent to that performed in the first exemplary embodiment, on the basis of the display device 140 (or an advertising image displayed in the display device 140) detected by the posted image detecting module 810.

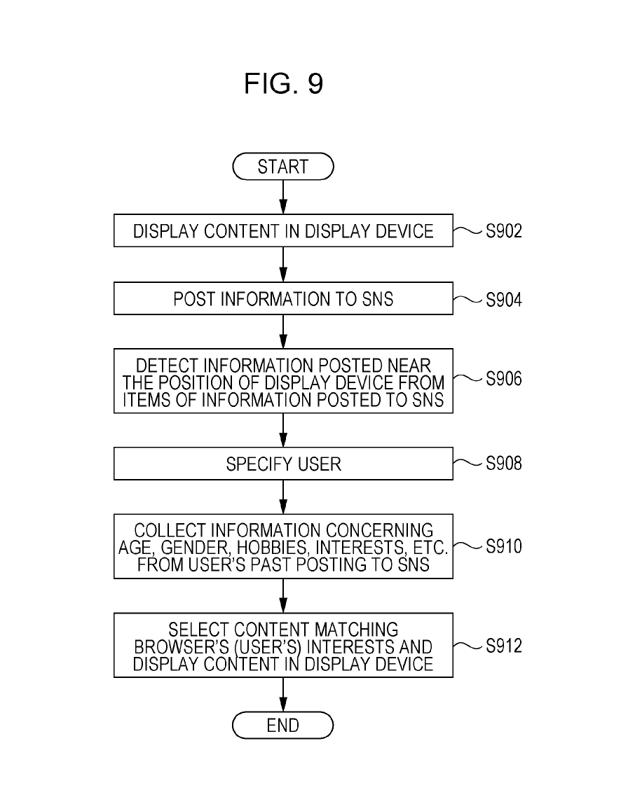

FIG. 9 is a flowchart illustrating an example of the processing performed by the information processing apparatus 100 of the second exemplary embodiment.

In step S902, the content display module 805 displays the content (advertising image) in the display device 140.

In step S904, the posting module 160 posts information to SNS in response to an operation performed by a user. The information posted in step S904 includes position information concerning a position of the browser terminal 150 detected by the position detecting module 855.

In step S906, the posted image detecting module 810 detects an item of information posted near the position of the display device 140 from among items of information posted to SNS.

In step S908, the user specifying module 115 specifies a user.

In step S910, the profiling module 120 collects information concerning the age, gender, hobbies, and interests of the user from the content of information posted to SNS in the past and the profile information.

In step S912, the content display module 125 selects the content that matches the browser's (user's) interests and displays the content in the display device 140.

The second exemplary embodiment may be combined with the above-described first exemplary embodiment. For example, the browser terminal 150 may take a picture of the display device 140, detect a position of the browser terminal 150, embed position information concerning the detected position in an image of the picture of the display device 140, and then post this image to SNS. Then, the information processing apparatus 100 may specify the display device 140 located near the browser terminal 150 by using the position information and then detect information embedded in the image. That is, by restricting the display device 140 by using the position information, the load on processing for detecting the information embedded in the image may be reduced.

The hardware configuration of a computer that executes a program which serves as the first or second exemplary embodiment (the information processing apparatus 100 or the browser terminal 150) is shown in FIG. 12. This computer is a general computer, and more specifically, a computer which serves as a personal computer (PC), a server, or a mobile terminal. The computer shown in FIG. 12 includes a CPU 1201, which serves as a processor (arithmetic unit), a RAM 1202, a read only memory (ROM) 1203, and an HD 1204, which serve as storage devices. The CPU 1201 executes a program of the content display module 105, the image detecting module 110, the user specifying module 115, the profiling module 120, the content display module 125, the imaging module 155, the posting module 160, and so on. The RAM 1202 stores therein this program and data. The ROM 1203 stores therein a program for starting the computer. The HD 1204 is an auxiliary storage device (may be a flash memory). The computer shown in FIG. 12 also includes an output device 1205, a receiver 1206, a communication line interface 1207, and a bus 1208. The output device 1205 is, for example, a cathode ray tube (CRT) or a liquid crystal display (LCD). The receiver 1206 receives data in response to an operation performed on a keyboard, a mouse, or a touch panel by a user. The communication line interface 1207 is, for example, a network interface card, and is used for connecting the computer to a communication network. The bus 1208 connects the above-described elements and allows them to send and receive data therebetween. The above-described computer may be connected to another computer configured similarly to this computer via a network.

In the above-described exemplary embodiments, concerning an element implemented by a computer program, this computer program, which is software, is read into a system having the hardware configuration shown in FIG. 12, and the above-described exemplary embodiments are implemented in a cooperation of software and hardware resources.

The hardware configuration shown in FIG. 12 is only an example. The exemplary embodiments are not restricted to the configuration shown in FIG. 12 and may be configured in any manner as long as the modules described in the exemplary embodiments are executable. For example, some modules may be configured as dedicated hardware (for example, an application specific integrated circuit (ASIC)), or some modules may be installed in an external system and be connected to the computer via a communication line. Alternatively, a system, such as that shown in FIG. 12, may be connected to a system, such as that shown in FIG. 12, via a communication line, and may be operated in cooperation with each other. Additionally, instead of into a PC, the modules may be integrated into a home information appliance, a copying machine, a fax machine, a scanner, a printer, or a multifunction device (an image processing apparatus including at least two functions of a scanner, a printer, a copying machine, and a fax machine).

The above-described program may be stored in a recording medium and be provided. The program recorded on a recording medium may be provided via a communication medium. In this case, the above-described program may be implemented as a “non-transitory computer readable medium storing the program therein” in an exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered), a magneto-optical disk (MO), a flexible disk (FD), magnetic tape, a hard disk, a ROM, an electrically erasable programmable read only memory (EEPROM) (registered), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a detector that detects, from first information posted by a user, display device identification information for uniquely identifying a display device which displays an advertising image;
an extracting unit that extracts information concerning interests of the user from the first information posted by the user or second information concerning the user; and
an associating unit that associates the display device identification information detected by the detector with the information concerning the interests of the user extracted by the extracting unit.

2. The information processing apparatus according to claim 1, wherein:
the first information is an image obtained by taking a picture of the advertising image, and the display device identification information is embedded in the advertising image; and
the detector detects the display device identification information from the image obtained by taking a picture of the advertising image.

3. The information processing apparatus according to claim 1, wherein:
the first information is position information indicating a position of a posting device used for posting the first information by the user; and
the detector detects the display device identification information corresponding to the position information.

4. An information processing apparatus comprising:
a detector that detects, from first information posted by a user, advertisement identification information for uniquely identifying an advertising image displayed in a display device;
an extracting unit that extracts information concerning interests of the user from the first information posted by the user or second information concerning the user; and
an associating unit that associates the advertisement identification information detected by the detector with the information concerning the interests of the user extracted by the extracting unit.

5. The information processing apparatus according to claim 4, wherein:
the first information is an image obtained by taking a picture of the advertising image, and the advertisement identification information is embedded in the advertising image; and
the detector detects the advertisement identification information from the image obtained by taking a picture of the advertising image.

6. The information processing apparatus according to claim 4, wherein:
the first information is an image obtained by taking a picture of the advertising image; and
the detector compares part of the image obtained by taking a picture of the advertising image with a predetermined advertising image so as to detect the advertisement identification information concerning the advertising image.

7. The information processing apparatus according to claim 4, wherein:
the first information is position information indicating a position of a posting device used for posting the first information by the user; and
the detector detects the advertisement identification information concerning the advertising image displayed in the display device corresponding to the position information.

8. The information processing apparatus according to claim 1, further comprising:
a display unit that displays an advertising image in the display device on the basis of the information concerning the interests of the user.

9. The information processing apparatus according to claim 4, further comprising:
a display unit that displays an advertising image in the display device on the basis of the information concerning the interests of the user.

10. An information processing method comprising:
detecting, from first information posted by a user, display device identification information for uniquely identifying a display device which displays an advertising image;
extracting information concerning interests of the user from the first information posted by the user or second information concerning the user; and
associating the detected display device identification information with the extracted information concerning the interests of the user.

11. An information processing method comprising:
detecting, from first information posted by a user, advertisement identification information for uniquely identifying an advertising image displayed in a display device;
extracting information concerning interests of the user from the first information posted by the user or second information concerning the user; and
associating the detected advertisement identification information with the extracted information concerning the interests of the user.

12. A non-transitory computer readable medium storing a program causing a computer to execute a process, the process comprising:
detecting, from first information posted by a user, display device identification information for uniquely identifying a display device which displays an advertising image;
extracting information concerning interests of the user from the first information posted by the user or second information concerning the user; and
associating the detected display device identification information with the extracted information concerning the interests of the user.

13. A non-transitory computer readable medium storing a program causing a computer to execute a process, the process comprising:
detecting, from first information posted by a user, advertisement identification information for uniquely identifying an advertising image displayed in a display device;
extracting information concerning interests of the user from the first information posted by the user or second information concerning the user; and
associating the detected advertisement identification information with the extracted information concerning the interests of the user.
